(19) United States
(12) Patent Application Publication
(10) Pub. No.: US 2016/0196582 A1
(43) Pub. Date: Jul. 7, 2016

(54) SUBSCRIBER LOCATION AUDIENCE INSIGHTS FOR ENTERPRISE NETWORKS

(71) Applicant: Verizon Patent and Licensing Inc., Arlington, VA (US)

(72) Inventors: Debra A. Stone, South Orange, NJ (US); Chandrashekhar Yeleswarapu, Walnut Creek, CA (US)

(21) Appl. No.: 14/588,477

(22) Filed: Jan. 2, 2015

(51) Int. Cl. G06Q 30/02; H04W 4/02; H04L 29/08

(52) U.S. Cl. CPC G06Q 30/0261; H04L 67/26; H04L 67/306; H04W 4/023; G06Q 30/0267; G06Q 30/0269

(57) ABSTRACT

One or more network devices provide, to a user device, a configuration file that identifies data collection parameters for the user device across multiple different applications residing on the user device. The network devices receive, from the user device, user input to indicate a brand of interest to the user, and receive a trigger request, which indicates that the user device is within proximity of a point of interest for the brand. The network devices generate, based on the trigger request, an engagement indication that includes the brand point of interest, a push messaging identifier of the user device, and a segment identifier for a database segment. The database segment represents multiple user profiles with a common set of characteristics in a user profile database. The network devices provide, to the user device and using the push messaging identifier, an advertisement that is targeted to the database segment.

### BACKGROUND

Targeted marketing efforts are designed to reach consumers with known traits to increase the likelihood of a positive response to marketing. Retailers want the ability to understand, campaign, engage, measure, and optimize marketing with high transparency across multiple locations. However, obtaining consumer data to support targeted marketing while avoiding privacy violations remains a challenge.

### BRIEF DESCRIPTION OF THE DRAWINGS

FIG. 1 is a diagram providing an overview of concepts described herein;

FIG. 2 is a diagram that depicts an exemplary network environment in which systems and methods described herein may be implemented;

FIG. 3 is a diagram of exemplary components of one of the devices of FIG. 2;

FIG. 4 is a block diagram of exemplary functional components of the user device of FIG. 2;

FIG. 5 is a block diagram of exemplary functional components of the brand environment of FIG. 2;

FIG. 6 is a block diagram of exemplary functional components of the insight server of FIG. 2;

FIG. 7 is a block diagram of exemplary functional components of the application programming interface (API) gateway of FIG. 6;

FIG. 8 is a block diagram of exemplary functional components of the analytics server of FIG. 2;

FIG. 9 is a diagram of exemplary fields of a customer profile that may be included within a user profile database;

FIGS. 10 and 11 are diagrams of exemplary communications among devices in a portion of the network environment of FIG. 2; and

FIGS. 12 and 13 are flow diagrams that illustrate an exemplary process for providing segmented user device data, according to an implementation described herein.

### DETAILED DESCRIPTION OF THE PREFERRED EMBODIMENTS

The following detailed description refers to the accompanying drawings. The same reference numbers in different drawings may identify the same or similar elements.

Systems and/or methods described herein collect data from user devices that can be provided to retail entities (also referred to herein as “brands”) in a manner that protects user privacy and allows for targeted marketing to the user devices. With the user's permission, a data collection application may be included within an existing application for a brand. In one implementation, the data collection application can be used and updated with multiple brand applications on the same user device. The collected data is grouped by segments and anonymized to enable access by retailers (e.g., for targeted marketing campaigns) without compromising user privacy. Thus, data collection and customized segmentation may be offered as a service to third parties. As used herein, “segments” may include groups of user profiles with common characteristics that may be used, for example, for targeted marketing campaigns.

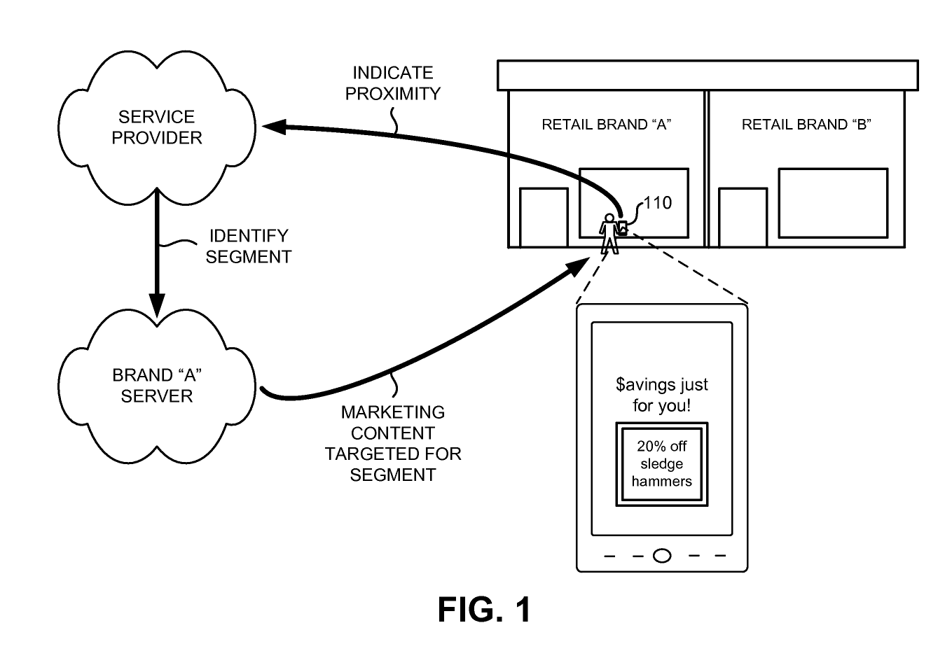

FIG. 1 provides an overview of concepts described herein. According to implementations described herein, a user of a user device 110 (e.g., a smart phone) may opt-in to provide device data (e.g., demographic data, location-based data, etc.) and brands of interest to the user. The device data and brands can be used to generate a user profile and associate the user profile with a particular segment. A shown in FIG. 1, the user of user device 110 may physically approach a retail location (e.g., retail brand “A”) that sells products for a brand “A.” According to implementations described herein, the proximity of user device 110 to retail brand “A” may be detected and indicated to a service provider (e.g., via a wireless internet connection or another type of network connection). Assuming brand “A” is of interest to the user, the devices in the service provider network may associate the user with a segment and identify the user's segment to, for example, a brand server for brand “A”. As described further herein, the brand server may use the segment information (and known characteristics for the segment) to direct marketing content to the user device 110 while the user is proximate to the retail location (also referred to as a user's “point of engagement” with the brand).

In one implementation, one or more network devices may provide, to a user device, a configuration file that identifies data collection parameters for the user device across multiple different applications residing on the user device. The network devices may receive, from the user device, user input to indicate a brand of interest to the user, and receive a trigger request, which indicates that the user device is within proximity of a point of interest for the brand. The network devices may generate, based on the trigger request, an engagement indication that includes the brand point of interest, a push messaging identifier of the user device, and a segment identifier for a database segment. The database segment may represent multiple user profiles with a common set of characteristics in a user profile database. The network devices may provide, to the user device and using the push messaging identifier, an advertisement that is targeted to the database segment. In some instances, the advertisement may be provided without identifying the user and without use of global positioning system (GPS) information.

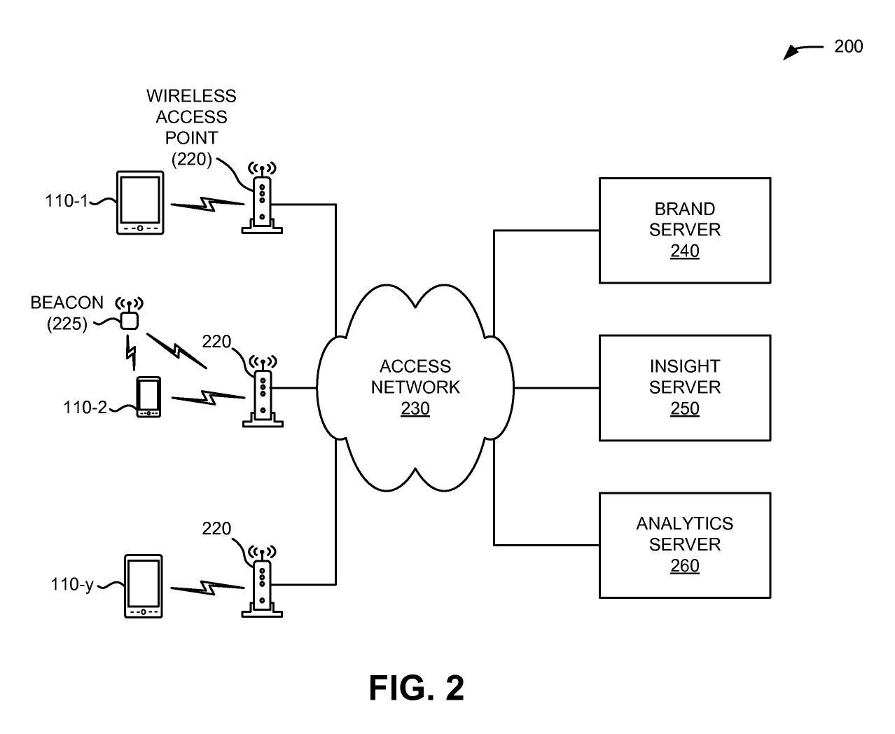

FIG. 2 is a diagram that depicts an exemplary network environment 200 in which systems and methods described herein may be implemented. As shown in FIG. 2, network environment 200 may include one or more user devices 110-1 through 110-y (also referred to herein collectively as “user devices 110” and generically as “user device 110”), one or more wireless access points 220 (also referred to herein collectively as “wireless access points 220” and generically as “wireless access point 220”), a beacon 225, an access network 230, one or more brand servers 240, an insight server 250, and an analytics server 260. Components of network environment 200 may be connected via wired and/or wireless links. In one implementation, components in network environment 200 may communicate using application programming interfaces (API) to regulate interactions between devices.

User device 110 may include a wireless telephone, a cellular telephone, a smart phone, a personal digital assistant (PDA) (e.g., that can include a radiotelephone, a pager, Internet/intranet access, etc.), a portable gaming system, a global positioning system, a tablet computer, a laptop computer, or other types of computation or communication devices. In an exemplary implementation, user device 110 may include any device that is capable of communicating over access network 230. User device 110 may operate according to one or more wireless communication standards such as broadband cellular standards (e.g., long-term evolution (LTE) network, wideband code division multiple access (WCDMA), etc.), local wireless standards (e.g., Wi-Fi®, Bluetooth®, near-field communications (NFC), etc.), or according to other communications standards.

In one implementation, user device 110 may store one or more applications (or “apps”) dedicated to a particular retailer or brand (referred to herein as “third-party brand apps”). For example, user device 110 may include a third-party brand app for a department store chain that complements online and in-store shopping or a third-party brand app for a brand (e.g., an electronics brand, a shoe brand, etc.) that promotes its product use and sales. According to implementations described herein, user device 110 may also include a local client extension (e.g., an added software component that supplements/enhances features of the third-party brand app), integrated with the third-party brand apps, to collect user location and user pattern data. Also, when the local client extension detects it is within range of a known wireless access point 220 or beacon 225 (e.g., with a particular Bluetooth® low energy (BTLE) identifier signal or iBeacon® identifier signal associated with a particular brand), the local client extension may cause user device 110 to announce a proximity event.

Wireless access point 220 may be configured to enable user devices 110 and other devices to communicate with each other. For example, wireless access point 220 may be configured to use IEEE 802.11 standards for implementing a wireless Local Area Network (LAN) network. In one implementation, wireless access point 220 may provide a periodic signal to announce its presence and name (e.g., a service set identifier (SSID)) to user devices 110.

Beacon 225 may include a simple beacon or a smart beacon that transmits a wireless signal that can be detected by user devices 110. The beacon signal may cover a relatively small geographical area and may contain a unique identifier (e.g., a Bluetooth® identifier) to enable a user device 110 to associate beacon 225 with a particular brand.

Access network 230 may include a communications network, a data network, or a combination of networks that connect user devices 110 and/or wireless access point 220 to brand server 240, insight server 250 and/or analytics server 260. For example, access network 230 may include a local area network (LAN), a wide area network (WAN), a metropolitan area network (MAN), a wireless network, an optical fiber (or fiber optic) network, or a combination of these or other networks. In addition or alternatively, access network 230 may be included in a radio network capable of supporting wireless communications to/from one or more devices in network environment 200, and the radio network may include, for example, an LTE network or a network implemented in accordance with other wireless network standards.

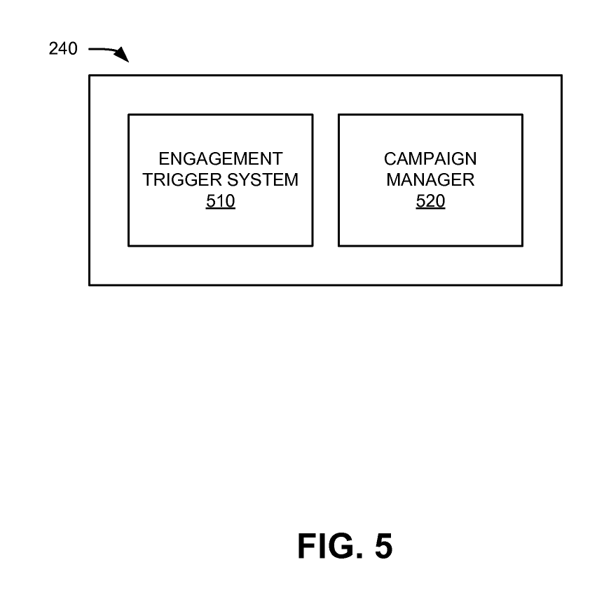

Brand server 240 may include a computation, communication, and/or network devices that operate to identify proximity of a user device 110 (e.g., equipped with a local client extension) to a brand location, so as to trigger a content recommendation. Brand server 240 may also provide recommended content to the user device 110. Features of brand server 240 are described further in connection with, for example, FIG. 5.

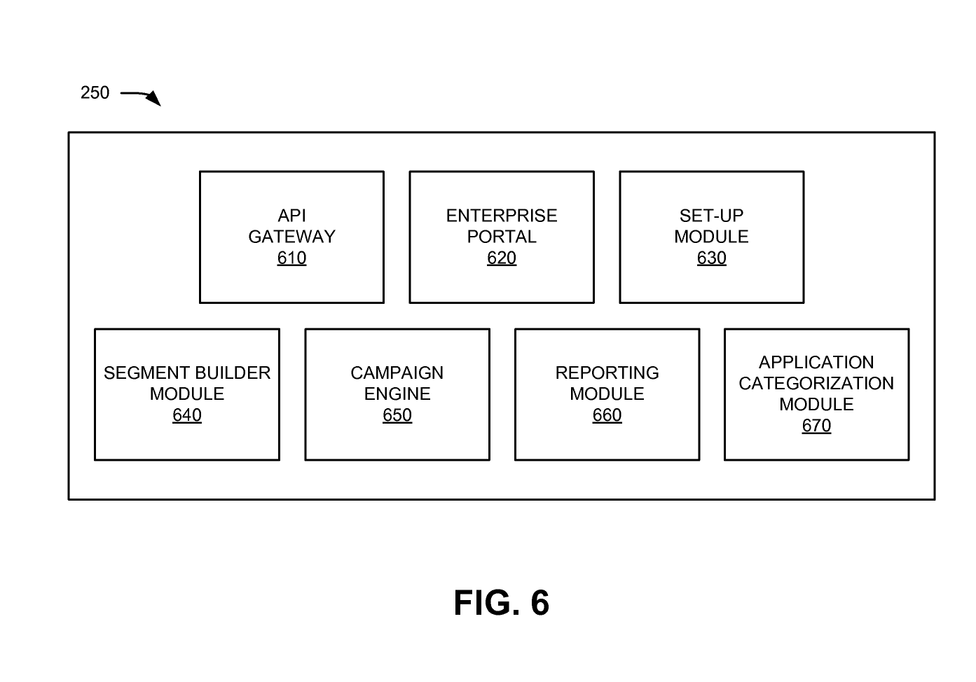

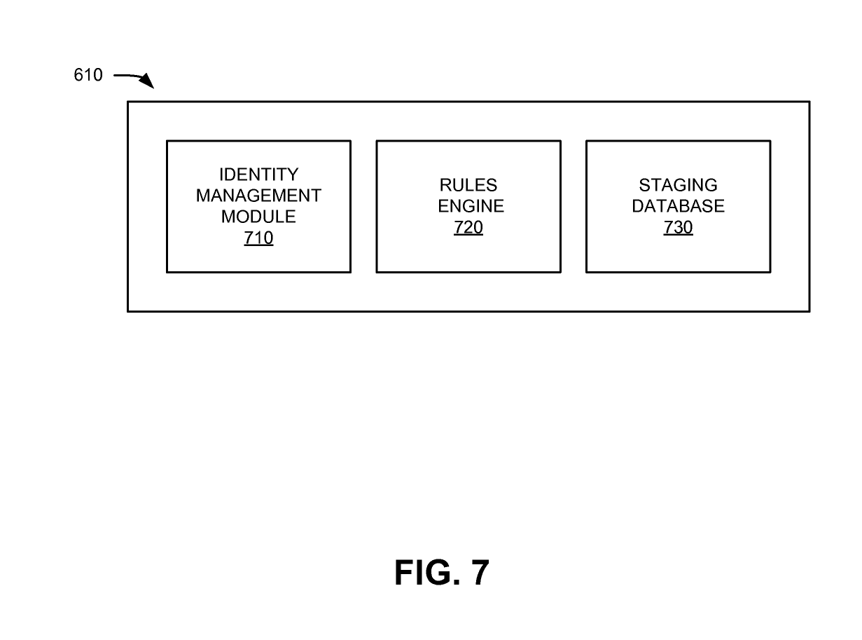

Insight server 250 may include a computation, communication, and/or network device to receive data extracted from user devices 110 and to allow new brands to configure their systems to join the data-sharing service of network environment 200. Insight server 250 may also provide retailers access to current segment definitions (e.g., as identified by analytics server 260) and/or allow retailers to define custom segments. In one implementation, insight server 250 may also push a configuration file to user devices 110. The configuration file may be used by user device 110 to identify and/or update brand locations (e.g., with an updated list of unique identifiers for wireless access points 220 and/or beacons 225 where a customer may be exposed to a brand) without requiring software upgrades to applications 430. In one implementation, the configuration file may be generated by a brand server. In another implementation, insight server may compile a configuration file for a user device using input from multiple brands. Although shown as a single element in FIG. 2, insight server 250 may include a number of separate networks. Features of insight server 250 are described further in connection with, for example, FIGS. 6 and 7.

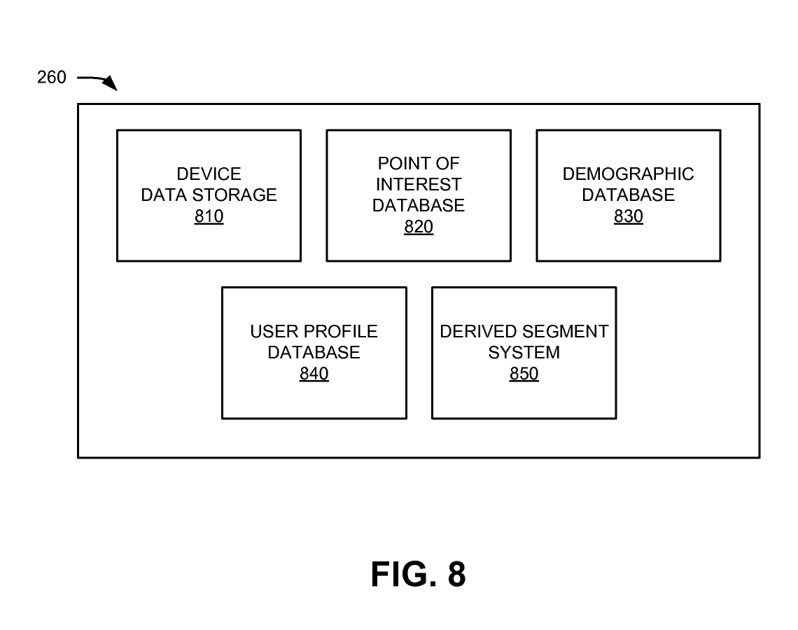

Analytics server 260 may include a computation, communication, and/or network device to convert raw user device 110 data into segmented data. In one implementation, analytics server 260 may be a private network that is protected/separated from other networks (such as access network 230, brand server 240, and/or insight server 250) by a firewall. In one implementation, analytics server 260 may combine the raw data with point of interest (e.g., locations associated with brands, etc.), demographics, and/or user profiles. Analytics server 260 may generate processed segments (e.g., that conform to privacy requirements) that are made available to brand server 240. Although shown as a single element in FIG. 2, analytics server 260 may include a number of separate networks. Features of analytics server 260 are described further in connection with, for example, FIG. 8.

According to implementations described herein, users of user devices 110 may download one or more third-party brand apps including a local client extension. The user may opt in to allow device data collection (e.g., proximity/location data) and inclusion of the device data in segmented data for the particular brand. The device data collection may include associating a user location with multiple points of interest (e.g., locations associated with different local wireless networks, cellular connections, or wired connections) and one or more third-party brand identifiers (corresponding to third-party brand apps, with the local client extension, that reside on user device 110). Once authorized by the user, initial user preferences and device data collected by the local client extension may be provided to insight server 250 on a periodic basis. Insight server 250 may receive the data, temporarily store the data, and perform identity chaining to associate a common identifier for device data (from the same user) from different network interface types.

Insight server 250 may provide the authorized, raw device data to analytics server 260. Analytics server 260 may merge the raw data with data from other databases, such as a point of interest database and a demographics database. After an introductory use period for each user (e.g., 30 days), insight server 250 may generate a user profile for each user using analytical algorithms the combine device data with data from the points of interest database and a demographics database. Each user profile may include a unique device identifier to enable a user device 110 to be recognized when in proximity to, for example, a wireless access point 220.

Customers (associated with brand server 240) may access insight server 250 to define relevant segments. Insight server 250 may provide the segment definitions to analytics server 260. The user profiles generated by analytics server 260 may be included in segment with matching segment attributes. Each brand may have access only to device data for which users have opted in for the particular brand. Analytics server 260 may provide the segments to brand server 240. To preserve anonymity, in one implementation, segments must contain a minimum number of profiles (e.g., 50, 100, 1000, etc.) before the segment can be provided to brand server 240. Segments may be used by brand server 240 to identify points of engagement for user devices 110 with, for example, brand retail locations. Brand server 240 may detect proximity of a particular user device 110 (based on a unique device identifier included in a segment) and may provide, for example, real-time targeted marketing to user device 110 based on the segment attributes.

In FIG. 2, the particular arrangement and number of components of network environment 200 are illustrated for simplicity. In practice there may be more mobile devices 110, wireless access points 220, access networks 230, brand servers 240, insight servers 250, or analytics servers 260. For example, there may be millions of user devices 110. In another example, insight server 250 and analytics server 260 may be combined.

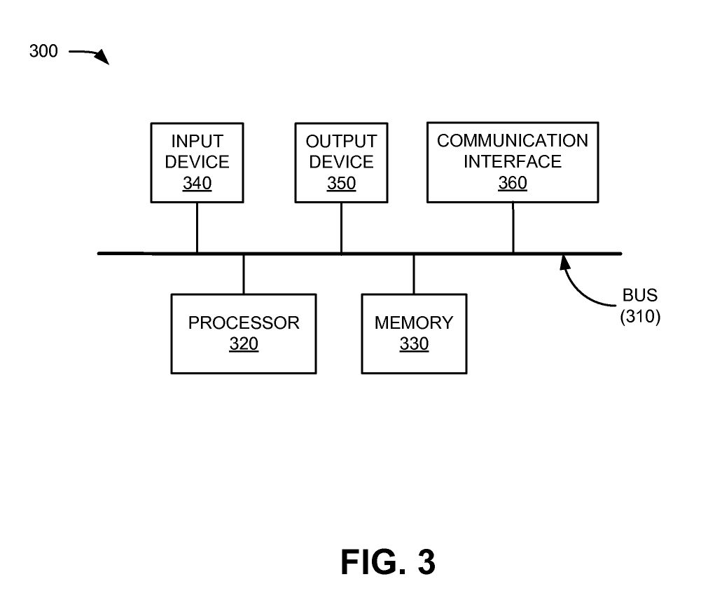

FIG. 3 is a diagram illustrating exemplary components of a device 300 according to an implementation described herein. User devices 110, brand server 240, insight server 250, and analytics server 260 may include one or more devices 300. As shown in FIG. 3, device 300 may include a bus 310, a processor 320, a memory 330, an input device 340, an output device 350, and a communication interface 360.

Bus 310 may include a path that permits communication among the components of device 300. Processor 320 may include any type of single-core processor, multi-core processor, microprocessor, latch-based processor, and/or processing logic (or families of processors, microprocessors, and/or processing logics) that interprets and executes instructions. In other embodiments, processor 320 may include an application-specific integrated circuit (ASIC), a field-programmable gate array (FPGA), and/or another type of integrated circuit or processing logic.

Memory 330 may include any type of dynamic storage device that may store information and/or instructions, for execution by processor 320, and/or any type of non-volatile storage device that may store information for use by processor 320. For example, memory 330 may include a random access memory (RAM) or another type of dynamic storage device, a read-only memory (ROM) device or another type of static storage device, a content addressable memory (CAM), a magnetic and/or optical recording memory device and its corresponding drive (e.g., a hard disk drive, optical drive, etc.), and/or a removable form of memory, such as a flash memory.

Input device 340 may allow an operator to input information into device 300. Input device 340 may include, for example, a keyboard, a mouse, a pen, a microphone, a remote control, an audio capture device, an image and/or video capture device, a touch-screen display, and/or another type of input device. In some embodiments, device 300 may be managed remotely and may not include input device 340. In other words, device 300 may be “headless” and may not include a keyboard, for example.

Output device 350 may output information to an operator of device 300. Output device 350 may include a display, a printer, a speaker, and/or another type of output device. For example, device 300 may include a display, which may include a liquid-crystal display (LCD) for displaying content to the customer. In some embodiments, device 300 may be managed remotely and may not include output device 350. In other words, device 300 may be “headless” and may not include a display, for example.

Communication interface 360 may include a transceiver that enables device 300 to communicate with other devices and/or systems via wireless communications (e.g., radio frequency, infrared, and/or visual optics, etc.), wired communications (e.g., conductive wire, twisted pair cable, coaxial cable, transmission line, fiber optic cable, and/or waveguide, etc.), or a combination of wireless and wired communications. Communication interface 360 may include a transmitter that converts baseband signals to radio frequency (RF) signals and/or a receiver that converts RF signals to baseband signals. Communication interface 360 may be coupled to an antenna for transmitting and receiving RF signals.

Communication interface 360 may include a logical component that includes input and/or output ports, input and/or output systems, and/or other input and output components that facilitate the transmission of data to other devices. For example, communication interface 360 may include a network interface card (e.g., Ethernet card) for wired communications and/or a wireless network interface (e.g., a Wi-Fi) card for wireless communications. Communication interface 360 may also include a USB port for communications over a cable, a Bluetooth™ wireless interface, a RFID interface, a NFC wireless interface, and/or any other type of interface that converts data from one form to another form.

As will be described in detail below, device 300 may perform certain operations relating to processing data from monitored devices 110 and/or applying rules for one or more monitored devices 110. Device 300 may perform these operations in response to processor 320 executing software instructions contained in a computer-readable medium, such as memory 330. A computer-readable medium may be defined as a non-transitory memory device. A non-transitory memory device may include memory space within a single physical memory device or spread across multiple physical memory devices. The software instructions may be read into memory 330 from another computer-readable medium or from another device via communication interface 360. The software instructions contained in memory 320 may cause processing unit 310 to perform processes that will be described later. Alternatively, hardwired circuitry may be used in place of, or in combination with, software instructions to implement processes described herein. Thus, implementations described herein are not limited to any specific combination of hardware circuitry and software.

Although FIG. 3 shows exemplary components of device 300, in other implementations, device 300 may include fewer components, different components, additional components, or differently-arranged components than those depicted in FIG. 3. Additionally or alternatively, one or more components of device 300 may perform one or more tasks described as being performed by one or more other components of device 300.

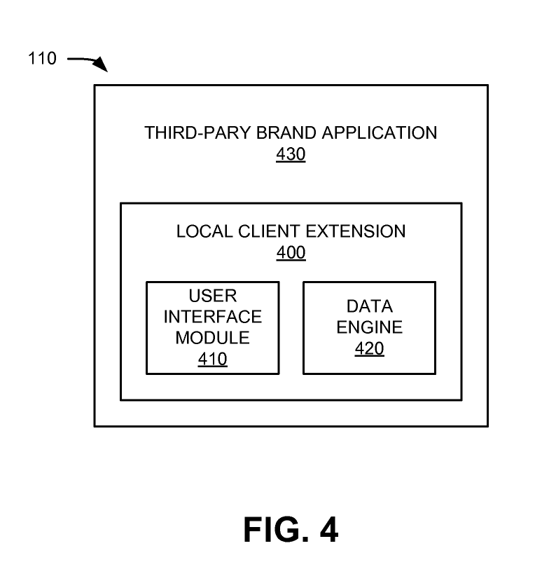

FIG. 4 is a diagram of exemplary functional components of user device 110. The functional components may be implemented by, for example, processor 320 in conjunction with memory 330. As shown in FIG. 4, user device 110 may include a local client extension 400 with a user interface module 410 and a data engine 420. Local client extension 400 may be included within a third-party brand application 430.

Local client extension 400 may include a software application installed on user device 110. Generally, local client extension 400 provides a user interface to incorporate user preferences (e.g., allowing a user to opt in—or opt out—of brand-aware data collection services, manage what data is collected, and manage what data can be made available to particular brands or groups of brands). Local client extension 400 may also perform data collection and reporting.

User interface module 410 may include an opt-in manager to request permission to collect device data (e.g., a one-time, initial setting). For example, user interface module 410 may present a notification window promoting the data collection service and providing a link to download data engine 420. User interface module 410 may also solicit permission to utilize a user profile. For example, user interface module 410 may request a user to opt-in and provide registration data to associate with a user profile, such as customer identifiers (e.g., an email address; social network identifiers such as a Facebook® ID, a Twitter® ID, etc.; customer loyalty program numbers; a phone number; and/or emergency contact information). User interface module 410 may also solicit permission for mobile engagement via proximity-based services and use of collected data for business insights/marketing. User interface module 410 may provide options to never track locations (e.g., causing any customer device ID to be excluded from analytics service reports) or to opt-in for a particular brand associated with third-party brand app 430 (e.g., indicating the user accepts advertising to be presented by the brand on the user's user device 110).

In another implementation, user interface module 410 may allow a user to opt-in (or opt-out) for any particular participating brand, regardless of whether the brand offers a corresponding third-party brand app 430. In one aspect, user interface module 410 may allow a user to indicate a category of brands such that insight server 250 my associated multiple brands of interest with the user based on the category. In one implementation, user interface module 410 may also provide an interface to track a user's particular brands (e.g., opt-in status, current offers, preferences, purchase history, customer loyalty number, etc.). In still another implementation, user interface module 410 may provide a listing of participating brands (e.g., for selection by the user).

Data engine 420 may perform data collection and proximity services for user device 110. Data collection may include collecting registration data information regarding a user's opt-in preferences, user device 110 model and operating system, personal profile, and brand preferences. Data engine 420 may also collect a Bluetooth ID and/or media access control (MAC) address associated with a user device 110. Data engine 420 may provide collected data to insight server 250. In one implementation, data engine 420 may also request a unique insight service ID, for user device 110, that is generated by insight server 250 (or another backend network). The insight service ID may be stored on user device 110 and included with any data uploaded by data engine 420. In one implementation, data engine 420 may communicate with an engagement trigger system 510 of brand server 240 (described below) to communicate a point of engagement of user device 110 with a particular retail brand location. In another implementation, data engine 420 may collect, store, and/or report location data for user device 110 on a period basis (e.g., for use in developing a user profile).

Third-party brand app 430 may include a software application dedicated to a particular retailer or brand. Third-party brand app 430 may generally provide promotions, simplified electronic purchasing, and/or other convenience features to generate consumer interest/loyalty. In one implementation, third-party brand app 430 may be configured to receive and present to a user real-time marketing offers triggered when a brand server 240 identifies a point of engagement by user device 110.

FIG. 5 is a diagram of exemplary functional components of brand server 240. The functional components may be implemented by, for example, processor 320 in conjunction with memory 330. As shown in FIG. 5, brand server 240 may include an engagement trigger system 510 and a campaign manager 520.

Engagement trigger system 510 may be used to detect a point of engagement of user devices 110 with a brand location. Engagement trigger system may employ one or more types of signaling devices to identify and report a proximity of user device 110 to beacons. In one implementation, engagement trigger system 510 may include a series of simple beacons (e.g., beacons 225) deployed in areas of interest, such as throughout various departments of a brand's retail stores. Each beacon 225 may broadcast an identifier signal that includes, for example, a brand unique universal identifier (UUID), a major number, and a minor number. The brand UUID may represent an identifier for the particular brand. The major number may represent a particular retail location and/or department. The minor number may represent a particular beacon in the retail location/department. When user device 110 is in range of a beacon 225, local client extension 400 may receive the beacon's advertisement and automatically send a trigger request to an identity management module 710 (describe below) within insight server 250. The trigger request based on a simple beacon may include, for example, the unique insight service ID for user device 110 and the beacon identifier (e.g., indicating a brand, retail location, and particular beacon).

In another implementation, engagement trigger system 510 may include smart beacons (e.g., beacon 225) deployed in a brand's areas of interest. The smart beacon may use, for example, Bluetooth® protocols to determine a Bluetooth ID® for user device 110. The smart beacon may send a trigger request to the identity management module 710 within insight server 250. The trigger request based on the smart beacon may include, for example, the Bluetooth ID® for user device 110 and the smart beacon identifier.

In still another implementation, engagement trigger system 510 may include wireless access point 220. Wireless access point 220 may obtain a MAC address from user device 110 when user device 110 joins a local wireless LAN serviced by wireless access point 220. Wireless access point 220 may send trigger request to the identity management module 710 within insight server 250. The trigger request based on wireless access point 220 may include, for example, MAC address of user device 110 and an identifier for wireless access point 220.

As described further below, whatever type of device is used to detect a point of engagement of user devices 110 with a brand location, engagement trigger system 510 or user device 110 may provide to insight server 250 (e.g., identity management module 710) some form of user device identifier that can be cross-referenced to a unique insight service identifier for user device 110.

Campaign manager 520 may receive an indication of engagement (for user device 110) from insight server 250 (e.g., as a result of a request sent by engagement trigger system 510). The indication of engagement may include a beacon ID for the triggering beacon, a push messaging ID for user device 110 (such as an Apple Push Notification (APN) device token or a Google Cloud Messaging (GCM) device ID) that allows communications to be pushed to user device 110, a unique insight service ID associated with user device 110, and/or a segment ID. Based on the indication of engagement, campaign manager 520 can determine a relevant advertisement to send to user device 110/local client extension 400. For example, campaign manager 520 may apply rules to provide to user device 110 a coupon, a discount, a promotion, or a notice associated with the particular location, time, and segment for the corresponding indication of engagement.

FIG. 6 is a diagram of exemplary functional components of insight server 250. The functional components may be implemented by, for example, processor 320 in conjunction with memory 330. As shown in FIG. 6, insight server 250 may include an application programming interface (API) gateway 610, an enterprise portal 620, a set-up module 630, a segment builder module 640, a campaign engine 650, a reporting module 660, and an application categorization module 670.

API gateway 610 may generally manage the receipt and initial routing of (1) periodic location data from user devices 110 and (2) trigger requests from user devices 110 or engagement trigger system 510. Functions of API gateway are described further in connection with FIG. 7. As shown in FIG. 7, API gateway 610 may include an identity management module 710, a rules engine 720, and a staging database 730.

Identity management module 710 may provide a secure environment for managing trigger request from user devices 110 or engagement trigger system 510 and providing indications of engagement to a brand's campaign manager 520. In one implementation, a brand server administrator may configure access rights and establish rules using an enterprise portal 620, as described further herein. Identity management module 710 may normalize trigger requests generated via simple beacons, smart beacons, or wireless access points 220 into a standard format. For example, identity management module 710 may cross-reference trigger requests using a Bluetooth ID® or MAC address to identify a corresponding unique insight service ID for user device 110. Identity management module 710 may also provide additional attributes to an incoming trigger request such as user profile information and/or a location zone.

Rules engine 720 may determine routing for a normalized trigger request. For example, a brand (e.g., using enterprise portal 620) may define routing rules for trigger requests that can be applied by rules engine 720. In one implementation, a rule may identify a brand ID, a trigger type (e.g., simple beacon, smart beacon, etc.), and a routing location. The routing location may be, for example, one of a brand-managed system (e.g., campaign manager 520) or a service provider system (e.g., campaign engine 650, described below). A brand-managed system may be used if brand server 240 includes features of campaign manager 520. The service provider system may be used to provide similar services as campaign manager 520, if a brand-managed system is not available.

Staging database 730 may include memory location for holding raw data received from user devices 110 and/or engagement trigger systems 510. In one aspect, staging database 730 may be periodically accessed by analytics server 260 to process general location and tracking data from user devices 110 for use in developing data segments.

Returning to FIG. 6, enterprise portal 620 may be configured as a web portal for brands to administer engagement triggers, assign beacons, define segments for opt-in profile, manage marketing campaigns, and/or configure reporting. In one implementation, enterprise portal 620 may work in conjunction with other functional components of insight server 250 (e.g., set-up module 630, segment builder module 640, campaign engine 650, and reporting module 660) to allow a network administrator for brand server 240 configure network settings.

Trigger set-up module 630 may allow the network administrator (via enterprise portal 620) to configure an engagement tracking system. As described above, engagement triggers may be generated using simple beacons, smart beacons, and/or wireless access points 220. Trigger set-up module 630 (accessed via enterprise portal 620) may allow a network administrator for a brand (e.g., brand server 240) to enable/disable any engagement triggers and configure routing of trigger request (e.g., to campaign manager 520 or recommendation engine 630) based on a brand or type of trigger. Trigger set-up module 630 may also allow the network administrator to add/edit/delete all beacon identifiers associated with a particular brand, retail location, and/or department.

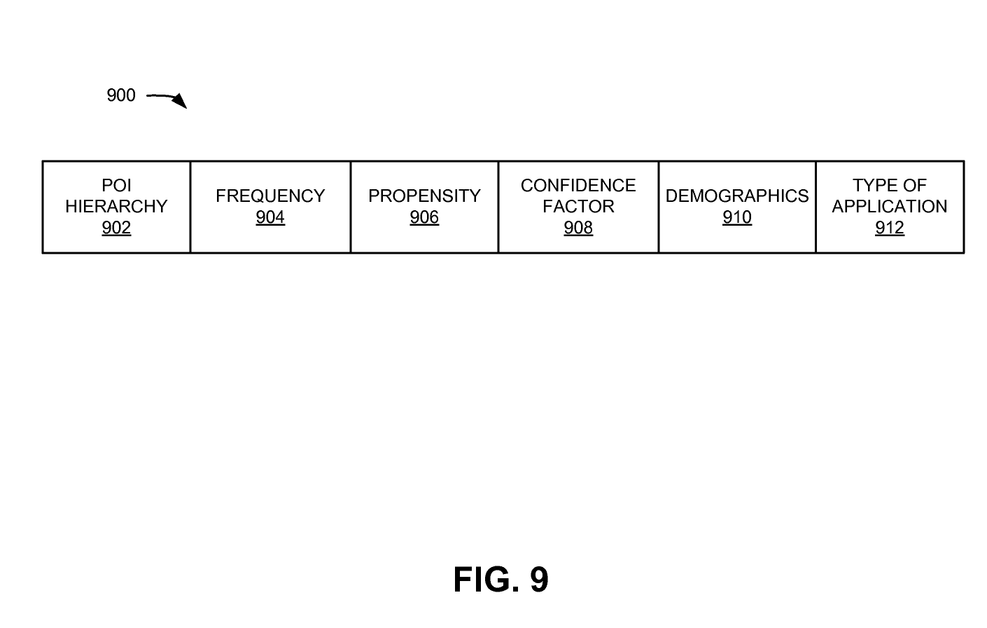

Segment builder module 640 may enable the administrator (via enterprise portal 620) to create a segment from data in, for example, derived segment system 850. Segment builder module 640 may partition all profile records to ensure a brand may only access profiles that have been authorized by the user. Each of the authorized profiles may have attributes (described further in connection with FIG. 9) that may be used to define a query. The administrator may use enterprise portal 620 to define a query and generate query results. The query result, including lists of particular user profiles, may be saved as a segment and stored locally within brand server 240 and/or insight server 250. In one aspect, the saved segments may be accessed by insight server 250 for real-time inquiry in response to a trigger request (e.g., to associate a unique insight service ID with one or more segments).

Campaign engine 650 may allow the administrator (via enterprise portal 620) to add/edit/delete an association between particular beacons and a unique advertising identifier (e.g., for an advertisement that can be sent to user device 110). In another implementation, the administrator may provide a rule or set of rules to allow campaign engine 650 to select from a set of advertisements depending on factors such as a time of day, a segment, etc. In another implementation, campaign engine 650 may draw upon predictive analytics to analyze current data and historical event to make content recommendations (e.g., particular advertisements/offers or categories of advertisements) for generating campaign rules.

Reporting module 660 may allow the administrator (via enterprise portal 620) to view reports, such as segment-based foot traffic near deployed beacons on the floor plan of the brand's retail location or statistics of segments (the number of consumers across various segments) near specific beacons of the brand's retail location. Reporting module 660 may generate reports in response to a particular request or on a periodic basis as indicated by the network administrator.

Application categorization module 670 may maintain a list of all process/application identifiers and map them back to application names (e.g., for applications 430). The application names may be sorted based on an application category (e.g., finance apps, entertainment apps, travel apps, retail apps, social networking apps, etc.).

FIG. 8 is a diagram of exemplary functional components of analytics server 260. The functional components may be implemented by, for example, processor 320 in conjunction with memory 330. As shown in FIG. 8, analytics server 260 may include device data storage 810, a point of interest database 820, a demographic database 830, a user profile database 840, and a derived segment system 850. In one implementation, components of analytics server 260 may include a cloud-based storage system of multiple networked devices.

Device data storage 810 may include a database that collects user device data 110. The device data may include a user's location data, as recorded by an operating system of user device 110, and which typically has three fields: latitude, longitude and accuracy. The device data also may include an indication of various application processes (e.g., unique brand application IDs) that are running on user device 110.

Point of interest database 820 may include a collection of geographic locations projected on a map. The locations may include retail locations (e.g., for particular brands), locations with particular demographics, or other areas that may be of interest. Data for point of interest database 820 may be collected independently from other data (e.g., such as device data storage 810 and demographic database 830).

Demographic database 830 may include demographic data for service provider subscribers or from general populations based on third-party data. Data for demographic database 830 may be collected independently from other data (e.g., such as device data storage 810 and point of interest database 820). Demographics database 830 may include the most accurate census level data that is available (e.g., to a city block level).

User profile database 840 may include user profiles based on user preferences and information collected from user devices 110. In one implementation, each profile in user database 840 may have an initial period (e.g., 15 days, 30 days, 60 days) before the profile is deemed mature enough for data analysis. For example, the user profile database 840 may store hosts user profiles that are built after collecting the user's device information for a period of thirty days and running analytical algorithms combining data from device data storage 810, point of interest database 820, and demographic database 830.

Derived segment system 850 may generate segments of relevant user profiles responsive to particular queries and/or brands. For example, a set of analytics may be run on the user profiles in user profile database 840 for which the initial period (e.g., 30 days) is complete. The analytics may be based on service provider criteria and/or third party criteria (e.g., as supplied by enterprise portal 620) and may identify segments. The segments are stored separately as processed segments that can be made available to brands (e.g., brand servers 240) participating in the insight service program.

FIG. 9 is a diagram of exemplary fields of a customer profile 900 that may be included within user profile database 840 and/or a segment generated by derived segment system 850. As shown in FIG. 9, customer profile 900 may include a point of interest (POI) hierarchy field 902, a frequency field 904, a propensity field 906, a confidence factor field 908, a demographics field 910, and a type of application field 912.

POI hierarchy field 902 may include particular stores, brands, cities, zip codes, etc., that identify an area of interest for a user. Frequency field 904 may include days/times associated with engaging a point of interest. Propensity field 906 may include an indication of a user device 110's propensity to be at a point of interest at a particular day/time.

Confidence factor field 908 may include a value indicative of a dwell time at a point of interest. For example, a two-minute dwell time at a point of interest may yield a 90% confidence factor that a user visited a location rather than drove past. Demographics field 910 may be derived based on the location of user device 110 that is determined to be the home residence (e.g., determined by location time stamping). Demographic field 910 may include, for example, a demographic identifier based on census data and collected user information (e.g., age, gender, etc). Type of application field 912 may be identify a category of a particular application (e.g., finance apps, entertainment apps, travel, etc.) based on categories of applications resident on user device 110.

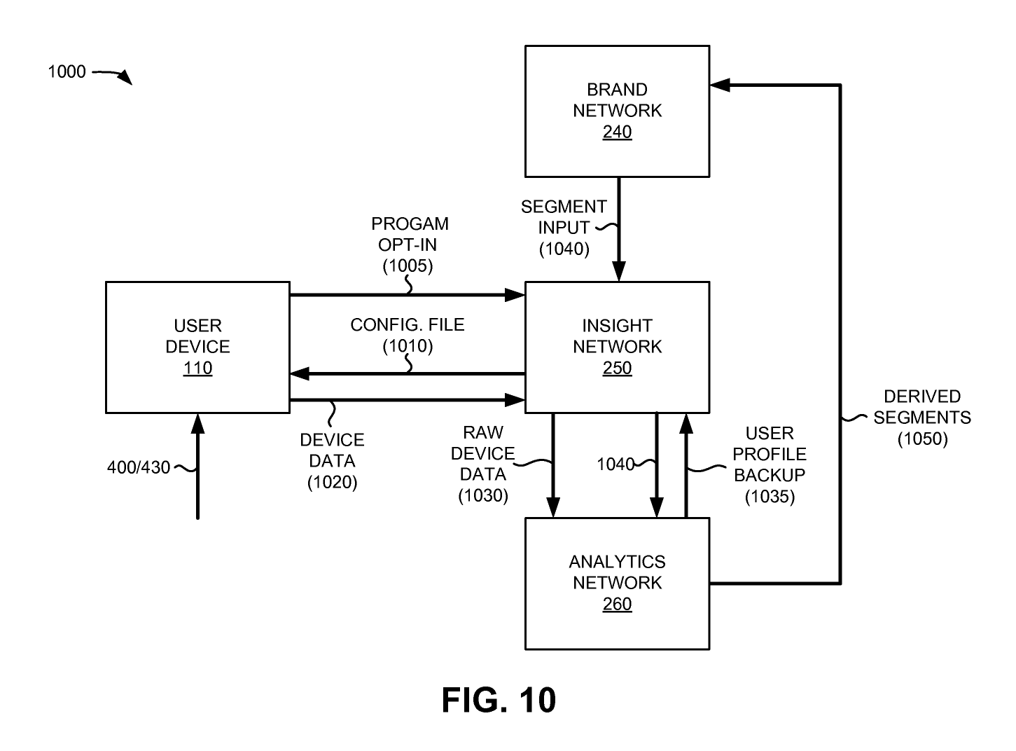

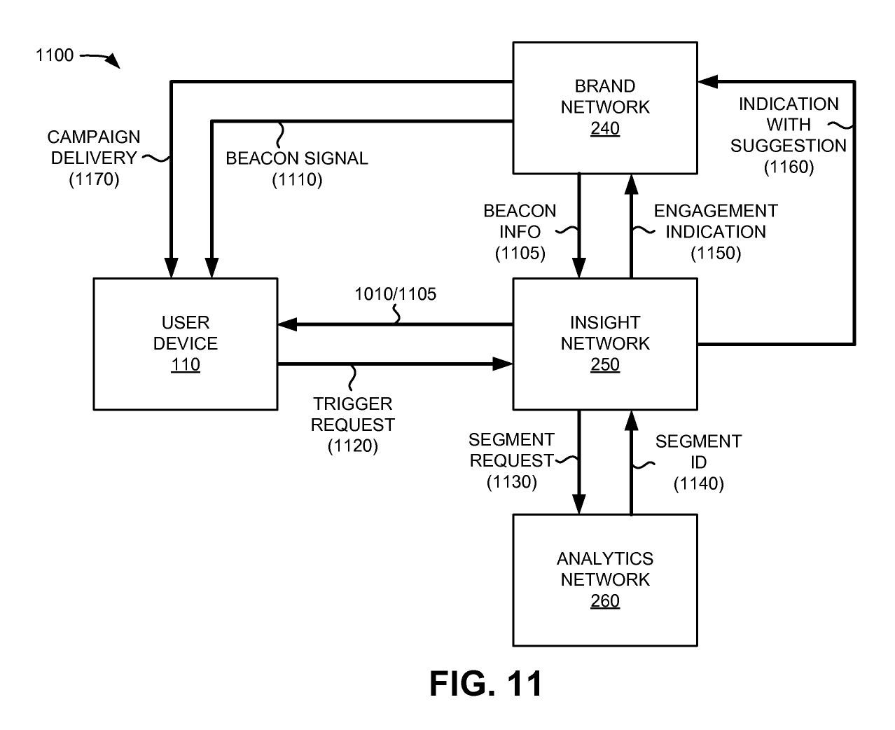

FIG. 10 is a diagram of exemplary communications among devices in a portion 1000 of network environment 200. Communications in FIG. 10 may represent communications for generating data segments from user device data that can be used for targeted marketing while maintaining user privacy. As shown in FIG. 10, network portion 1000 may include user device 110, brand server 240, insight server 250, and analytics server 260. User device 110, brand server 240, insight server 250, and analytics server 260 may include features described above in connection with, for example, FIGS. 1-8.

As shown in FIG. 10, user device 110 may download third-party brand application 430 (e.g., from an online media service or “app store”). Third-party brand application 430 may include a local client extension 400, as described above in connection with FIG. 4. User device 110 may prompt a user to opt-in to data collection services and identify particular brands or locations of interest. The user input may be provided to insight server 250 as program opt-in 1005. Insight server 250 may provide a configuration file 1010 to user device 110 that defines how local client extension 400 will format data and/or provide data from user device 110.

Based on local client extension 400 and/or configuration file 1010, user device 110 my provide device data 1020 to insight server 250. Device data 1020 may include, for example, time-stamped location data obtained by an operating system of user device 110 and brand preference indicators (e.g., based on third-party brand application 430). User device 110 may send device data 1020 on a periodic basis. In one implementation, local client extension 400 may apply one or more rules to manage delivery of device data 1020 in a manner that minimizes limited wireless spectrum. For example, local client extension 400 may store device data 1020 until a local wireless connection is available, or up to a maximum time interval (e.g., 6 hours, 12 hours, etc.), to limit use of cellular network resources.

Insight server 250 may confirm device data 1020 is from an authorized user device (with a valid opt-in) and may format device data 1020 into a common format (e.g., associated with a unique insight service ID for the user). Insight server 250 may provide the data to analytics server 260 as raw device data 1030. As described above in connection with FIG. 8, analytics server 260 may process raw device data 1030 with other point of interest data and demographics data to create user profiles. In one implementation, the user profiles may be stored locally within analytics server 260 and provided as user profile backup 1035 to insight server 250.

Analytics server 260 may derive data segments from the user profiles. The data segments may include, for example, data from user profiles that have opted in to allow sharing with a particular brand. In one implementation, segments may be generated based on queries and statistical analysis from a service provider (e.g., associated with analytics server 260 or insight server 250). In another implementation, segments may be generated based on queries from brand server 240. For example, brand server 240 may provide segment input 1040 to insight server 250 (e.g., via enterprise portal 620) which may be provided to analytics server 260 to initiate a query. Segments related to a particular brand may be provided to brand server 240 as derived segments 1050.

FIG. 10 is a diagram of other exemplary communications among devices in portion 900 of network environment 200. Communications in FIG. 10 may represent communications for providing targeted marketing content to participating user devices using a simple beacon trigger.

As shown in FIG. 10, brand server 240 may provide beacon information 1005 to insight server 250. Beacon information 1005 may include a brand UUID associated with a particular brand (e.g., for brand server 240). Insight server 250 may receive beacon information 1005 and forward beacon information 1005 to user device 110 (e.g., as part of configuration file 910, for example). Beacon information 1005 may allow user device 110 to identify beacon signals relevant to brand server 240 while ignoring other beacon signals (e.g., from other brands not of interest to the user).

User device 110 may receive and store configuration file 910 and beacon information 1005. When user device 110 is within signal range of a beacon associated with brand server 240, user device 110 may detect a beacon signal 1010. User device 110 may identify the brand UUID of the beacon signal to determine the signal is from a brand relevant to the user. In response to beacon signal 1010, user device 110 (e.g., local client extension 400) may send a trigger request 1020 to insight server 250. Trigger request 1020 may include a unique insight service ID for user device 110 and the beacon identifier (e.g., indicating a brand, retail location, and particular beacon).

Insight server 250 may detect the brand (e.g., brand server 240) associated with trigger request 1020 based on the beacon identifier. Additionally, insight server 250 may submit a segment request 1030 to analytics server 260 to determine a segment, relevant to the brand, that is associated with user device 110. Segment request 1030 may include, for example, the beacon ID, a push messaging ID (e.g., GCM device ID or APN device token), and the unique insight service ID for user device 110. Analytics server 260 will identify a segment ID 1040 based segment request 1030 and may provide segment ID 1040 to insight server 250.

Depending on the configuration preferences and/or capabilities of brand server 240, insight server 250 may respond to segment ID 1040 in different ways. If brand server 240 is configured with its own campaign managing capability (e.g., campaign manager 520), insight server 1050 may, in turn, provide an engagement indication 1050 to brand server 240. Engagement indication 1050 may include the beacon ID, the push messaging ID, and the unique insight service ID for user device 110, and segment ID 1040.

If brand server 240 is configured to use the service provider network to recommend marketing content, analytics server 260 (e.g., campaign engine 650) may identify an advertisement or other content that is relevant to the current trigger request 1020. Insight server 1050 may then provide an engagement indication with content suggestion 1060 to brand server 240. Indication with suggestion 1060 may include, for example, the beacon ID, the push messaging ID, segment ID 1040, and an advertisement identifier.

Brand server 240 may receive either of engagement indication 1050 or indication with suggestion 1060. In response to engagement indication 1050, brand server 240 may generate its own content recommendation and retrieve the corresponding content. In response to indication with suggestion 1060, brand server 240 may retrieve the suggested content item. In either event, brand server 240 may use the push messaging ID of user device 110 to provide a campaign delivery 1070 with the advertising content item to user device 110. In one implementation, campaign delivery 170 may be provided in near real time, while user device 110 is still within the proximity of beacon signal 1010.

Although FIG. 10 provides exemplary communications for providing targeted marketing content to participating user devices, in other implementations, other communications may be used. For example, as described above in connection with FIG. 5, brand server 240 may employ a smart beacon to send a trigger request to insight server 250 instead of relying on user device 110. Alternatively, as also described above in connection with FIG. 5, brand server 240 may use wireless access point 220 to send a trigger request to insight server 250.

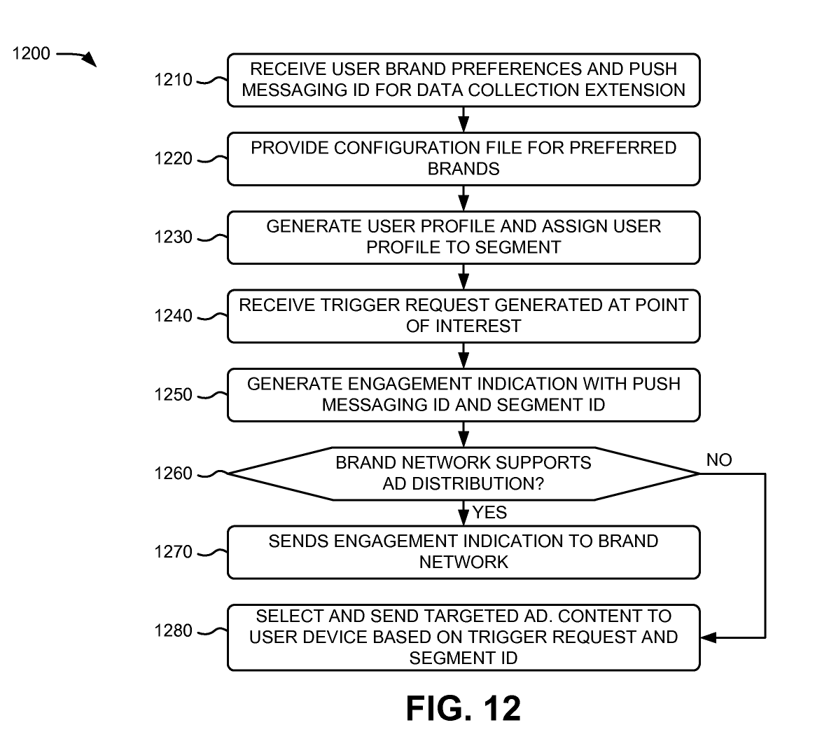

FIG. 12 is a flow diagram that illustrates an exemplary process 1200 for providing segmented user device data. In one implementation, process 1200 may be implemented by insight server 250. In another implementation, process 1200 may be implemented by insight server 250 in conjunction with one or more other devices or networks in network environment 200, such as wireless access point 220, brand server 240, and/or analytics server 260.

Process 1200 may include receiving user brand preferences and a push messaging identifier for a data collection extension (block 1210). For example, local client extension 400 within application 430 may solicit user input for preferred brands (e.g., associated with application 430 or multiple applications 430) and solicit or automatically detect other configuration information, such as a GCM device ID or an APN device token for user device 110. User device 110 may provide the user input and/or detected information to insight server 250, where it can be stored for use in a future user profile.

Process 1200 may also include providing a configuration file for the preferred brands (block 1220). For example, insight server 250 may provide one or more configuration files 910 that identifies data collection parameters for user device 110 across multiple copies of local client extension 400 (e.g., on different applications 430 residing on user device 110). Configuration file 910 may include identifiers for beacons 225 and/or wireless access points 220 associated with particular brands.

Process 1200 may further include generating a user profile and assigning the user profile to a segment (block 1230). For example, insight server 250 may provide raw or normalized device data from user device 110 to analytics server 260. Analytics server 260 may, in turn, combine the device data with brand location data and demographic data to create a user profile for user device 110.

Process 1200 may additionally include receiving a trigger request generated at point of interest (block 1240), and generating an engagement indication with a push messaging identifier and a segment identifier (block 2250). For example, insight server 250 may receive a signal from user device 110, wireless access point 220, and/or a proximate brand beacon that indicates the user device is within proximity of a point of interest for the brand (such as a retail store, a department within a store, etc.). Insight server may generate, based on the trigger request, an engagement indication that includes the brand point of interest, a push messaging identifier of user device 110, and a segment identifier for a database segment associated with the user profile for device 110.

Process 1200 may also include identifying if the brand server supports advertising (ad) distribution (block 1260). For example, insight server 250 may apply one or more rules from rules engine 720 to determine if brand server 240 can respond to a trigger request with its own content recommendation system (e.g., campaign manager 520) or if insight server 250 (e.g., campaign engine 650) will respond to the trigger request.

If the brand server supports ad distribution (block 1260, YES), then the engagement indication may be sent to the brand server (block 1270). For example, insight server 250 may forward engagement indication 1050 to brand server 240, if rule engine 720 indicates brand server 240 supports ad distribution.

If the brand server does not support ad distribution, then target advertising content may be selected and sent to the user device, based on the trigger request and the segment identifier (block 1280). For example, insight server 250 may use the segment ID and stored advertising content from brand server 240 select appropriate advertising content for user device 110. In one implementation, insight server 250 may send an indication with suggestion 1060 to brand server 240 for eventual distribution to user device 110. In another implementation, insight server 250 may send the advertising content directly to user device 110.

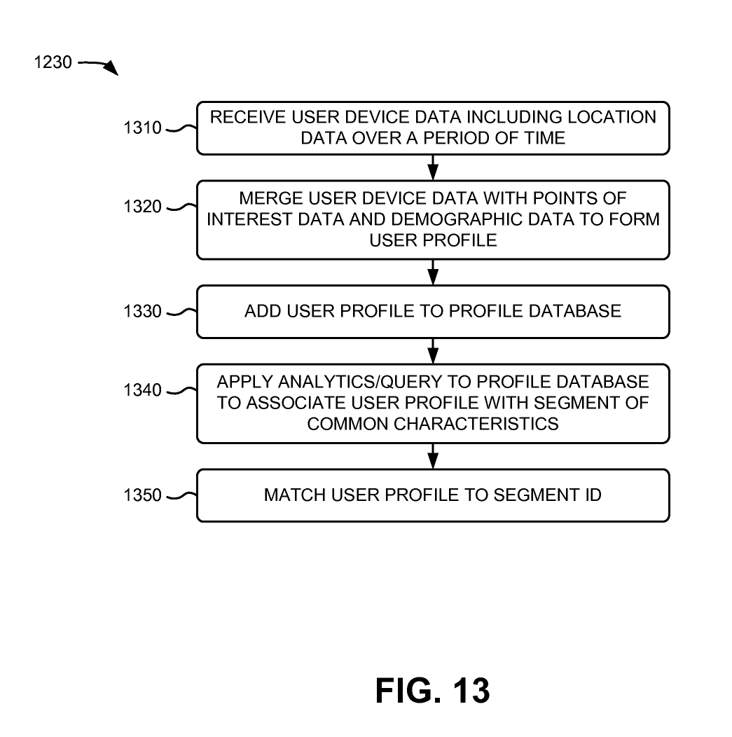

Process block 1230 may include the process blocks shown in FIG. 13. Referring to FIG. 13, process block 1230 may include receiving user device data including location data over a period of time (block 1310), and merging the user device data with points of interest data and demographic data to form a user profile (block 1320). For example, insight server 250 may receive device data 920 with location information from user device 110 at periodic intervals. Insight server 250 may perform look-ups to match a user ID with an unique insight service identifier (e.g., identity chaining) and/or normalize the data format before providing the data to analytics server 260. Analytics server may combine the user device data with data from point of interest database 820 and demographic database 830 to create a user profile.

Process block 1230 may also include adding the user profile to a profile database (block 1330), applying analytics and/or a query to the profile database to associate the user profile with a segment of common characteristics (block 1340), and matching the user profile to a segment identifier (block 1350). For example, analytics server 260 may store the user profile in user profile database 840. Analytics server 260 may identity segments within user profile database based on analytics and/or customized queries provide via enterprise portal 620. In one implementation, analytics server 260 may require a minimum segment size (e.g., 50 or more user profiles) before a segment can be defined and/or accessed by brand server 240. Analytics server 260 may assign a segment identifier to an identified segment, and the segment identifier may be associated with an individual user profile.

The foregoing description of implementations provides illustration and description, but is not intended to be exhaustive or to limit the invention to the precise form disclosed. Modifications and variations are possible in light of the above teachings or may be acquired from practice of the invention. For example, while series of blocks have been described with regard to FIGS. 12 and 13, the order of the blocks may be modified in other embodiments. Further, non-dependent blocks may be performed in parallel.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
providing, to a user device and by one or more network devices in a service provider network, a configuration file that identifies data collection parameters for the user device across multiple different applications residing on the user device;
receiving, from the user device and by the one or more network devices, user input to indicate a brand of interest to the user;
receiving, by the one or more network devices, a trigger request, wherein the trigger request indicates that the user device is within proximity of a brand point of interest;
generating, by the one or more network devices and based on the trigger request, an engagement indication that includes the brand point of interest, a push messaging identifier of the user device, and a segment identifier for a database segment, wherein the database segment represents multiple user profiles with a common set of characteristics in a user profile database; and
providing, to the user device and using the push messaging identifier, an advertisement that is targeted to the database segment.

2. The method of claim 1, further comprising:
receiving, by the one or more network devices and from the user device, device data for the user device, wherein the device data includes registration data, and location data over a period of time;
merging, by the one or more network devices, the device data with geographic points of interest data and demographic data to generate a user profile;
adding, by the one or more network devices, the user profile to a user profile database; and
assigning, by the one or more network devices, the user profile to the segment of the user profile database.

3. The method of claim 2, further comprising:
sending, to a brand server, the segment of the user profile database without identifying the user.

4. The method of claim 2, wherein the registration data includes:
user input to opt-in for brand-aware data collection services;
one or more customer identifiers; and
one or more device identification numbers.

5. The method of claim 1, wherein receiving the trigger request includes one of:
receiving a signal from a user device in response to the user device detecting a beacon signal associated with the brand, or
receiving a signal from a beacon associated with the brand in response to the beacon detecting a user device.

6. The method of claim 1, wherein the point of interest for the brand includes:
a store location, or
a department within a particular store.

7. The method of claim 1, wherein the trigger request includes one of:
a media access control (MAC) address for the user device,
a Bluetooth® low energy (BTLE) identifier for the user device,
the push messaging identifier for the user device,
a customer loyalty number for the user of the user device, or
a social network identifier for a user of the user device; and
wherein the method further comprises:
identifying, based on the trigger, a unique insight service identifier for the user device.

8. The method of claim 1, wherein providing an advertisement that is targeted to the database segment further comprises:
providing the advertisement when the user device is in the proximity of the brand point of interest.

9. The method of claim 1, wherein the configuration file further includes a list of service set identifiers (SSIDs) and beacon identifiers of devices at points of interest for the brand of interest to the user.

10. The method of claim 1, further comprising:
sending, by the one or more network devices and to a brand server, the engagement indication; or
selecting, by the one or more network devices and based on the engagement indication, the targeted advertisement from a group of targeted advertisements for the brand of interest to the user.

11. The method of claim 1, further comprising:
receiving brand segment definitions from a network administrator for the brand of interest; and
storing the brand segment definitions.

12. A system, comprising:
a memory configured to store a plurality of instructions; and
one or more processors configured to:
provide, to a user device, a configuration file that identifies data collection parameters for the user device across multiple different applications residing on the user device;
receive, from the user device, user input to indicate a brand of interest to the user;
receive a trigger request, wherein the trigger request indicates that the user device is within proximity of a brand point of interest;
generate, based on the trigger request, an engagement indication that includes the brand point of interest, a push messaging identifier of the user device, and a segment identifier for a database segment, wherein the database segment represents multiple user profiles with a common set of characteristics in a user profile database; and
provide, to the user device and using the push messaging identifier, an advertisement that is targeted to the database segment.

13. The system of claim 12, wherein, when receiving the trigger request, the one or more processors are configured to identify the user device from one of a media access control (MAC) address or a unique insight service identifier in the trigger request.

14. The system of claim 12, wherein the user input to indicate a brand of interest to the user includes a category of brand, and wherein the one or more processors are configured to determine one or more brands of interest to the user based on the category.

15. The system of claim 12, wherein the one or more processors are further configured to:
provide the advertisement when the user device is in the proximity of the brand point of interest.

16. The system of claim 15, wherein the one or more processors are further configured to:
send, to a brand server, the engagement indication; or
select the advertisement from a group of targeted advertisements for the brand of interest to the user, and send the advertisement to the user device.

17. The system of claim 12, further comprising:
receiving, from the user device, device data for the user device, wherein the device data includes registration data, and location data over a period of time;
merging the device data with geographic points of interest data and demographic data to generate a user profile;
adding the user profile to the user profile database; and
assigning the user profile to the database segment of the user profile database.

18. A non-transitory computer-readable medium containing instructions executable by at least one processor, the computer-readable medium comprising one or more instructions for:
providing, to a user device, a configuration file that identifies data collection parameters for the user device across multiple different applications residing on the user device;
receiving, from the user device, user input to indicate a brand of interest to the user;
receiving a trigger request, wherein the trigger request indicates that the user device is within proximity of a brand point of interest;
generating, based on the trigger request, an engagement indication that includes the brand point of interest, a push messaging identifier of the user device, and a segment identifier for a database segment, wherein the database segment represents multiple user profiles with a common set of characteristics in a user profile database; and
providing, to the user device and using the push messaging identifier, an advertisement that is targeted to the database segment.

19. The non-transitory computer-readable medium claim 18, further comprising one or more instructions for:
receiving, from a brand server, another configuration file with an updated list of service set identifiers (SSIDs) and beacon identifiers; and
sending to the user device the other configuration file.

20. The non-transitory computer-readable medium claim 18, further comprising one or more instructions for:
receiving, from the user device, device data for the user device, wherein the device data includes and location data over a period of time; and
merging the device data, with geographic points of interest data for the brand and demographic data, to generate a user profile.
